(19) United States
(12) Patent Application Publication
(10) Pub. No.: US 2009/0248538 A1
(43) Pub. Date: Oct. 1, 2009

(54) Facilitated mobile transactions

(76) Inventor: William Stuart Ervin Taylor, San Francisco, CA (US)

Correspondence Address: LUMEN PATENT FIRM, 350 Cambridge, Suite 100, PALO ALTO, CA, 94306, US

(21) Appl. No.: 12/322,064

(22) Filed: Jan. 27, 2009

Related U.S. Application Data
(60) Provisional application No. 61/062,798, filed on Jan. 28, 2008.

(51) Int. Cl. G06Q 20/00; G06Q 30/00

(52) U.S. Cl. 705/26; 705/39

(57) ABSTRACT

A stand-in payment and transaction facilitator system is provided. A merchant registers their details with a transaction facilitator and is assigned a merchant identifier. When a mobile user transacts with the merchant, the merchant identifier is communicated to the user's mobile device. At the payment step, the transaction facilitator uses the merchant's details referenced by their identifier to complete the payment portion of the transaction using any non-cash payment mechanism or service of the users choosing. The transaction facilitator offers for-purchase items from the merchants. The merchants use preferred payment providers. Communication devices are used to select for-purchase items from the transaction facilitator. The transaction facilitator communicates payment information received from the communication device to a financial transaction network for payment in the transaction to purchase the for-purchase item. On payment approval, the transaction facilitator communicates payment approval and a selected for-purchase item list to the merchant.

### CROSS-REFERENCE TO RELATED APPLICATIONS

This application is cross-referenced to and claims the benefit from U.S. Provisional Application 61/062,798 filed Jan. 28, 2008, and which are hereby incorporated by reference.

### FIELD OF THE INVENTION

The invention relates generally to a system for facilitating transactions. In particular, the invention relates to a system involving payment transactions where the need to pre-register and/or store the card details of the consumer by the merchant is eliminated to enable impromptu transactions between mobile devices and a local or remote merchant or service provider.

### BACKGROUND

The growth of mobile commerce is impeded by the current state of the art in consumer payment technology. Despite the major advances in portable device technology and in UI design, typified by the Account-On-File (AOF) process. AOF requires the consumer to pre-register their payment instrument(s) on a web site or with an internet service provider in advance of any transaction taking place. Although this approach works for some consumers and some, typically closed loop, merchants, studies have shown that many users are reluctant to register and store their payment information in an unknown location out on the “world-wild-web”. If the mobile user is not registered or a registered user desires to use a different payment instrument for any reason, they are prevented from making their purchase. The consumer suffers from a lack of convenience and the merchant or service provider potentially loses a revenue opportunity.

The account-on-file method has at least three major disadvantages:
(i) The user (consumer, client or customer) must be pre-registered on the site and/or with the service provider before a transaction can occur. This constraint severely limits the execution of ad-hoc transactions.
(ii) The consumer is limited to using only the registered payment card or account, which may not be convenient or desired at the time a transaction is attempted.
(iii) The consumer's credit, debit or other payment information is held on file, which exposes the data to potential hackers. Unfortunately fraud and identify theft has been the result of hackers breaking into many web-based or otherwise hosted account on file systems.

Account on file systems have a further disadvantage in that they add another degree of complexity for any merchant or service provider not directly operating the system. For example, the account on file transactions must be reconciled and settled at the end of day or shift. Most merchants and service providers desire to use a single or limited number of transaction acquiring relationships in order to simplify the settlement process and negotiated transaction fee structure.

In the traditional card transaction, the only pre-defined relationships that exist are between the card issuer and the consumer, and between the merchant and a payment transaction acquirer (preferred payment provider). As a result, a consumer can walk into any merchant, browse that merchants menu board of goods or services, make a selection and make a payment.

In mobile commerce, a transaction is more complicated, as the consumer usually also has a relationship with the merchant, for example in the form of having a transaction history. In this case a payment method is previously defined and stored by the merchant or preferred payment provider. If a consumer goes to a merchant's website to make a purchase and pays with a payment intermediary service that facilitates worldwide e-commerce, the payment intermediary service acts as a Payment service provider or proxy and uses the consumer's bankcard or credit card, for example, the details are store in the merchant's system or in the system of the payment intermediary service provider. Similarly a merchant can have the card details on file and bill the card each time a purchase is made. In environments where it is practical to have an account previously set up, purchases are readily made. However, the need to pre-register the card details of the consumer prohibits ad hoc or impromptu transactions from a mobile device. For example, when a consumer is travelling, they might not have a pre-registered relationship with the toll way operator, parking meter/garage-company, gas station or restaurant that the consumer knows is at the next exit on the freeway. Because the consumer does not have a prior relationship with these merchants a remote transaction with that merchant (or machine) cannot be made. More specifically, mobile payment transactions typically occur with pre-registered details, e.g. regarding credit card or bankcard, that are on file with a server and directly accessible by the merchant or service provider at the time of a transaction. Unfortunately, the completion of a payment transaction is rather difficult when the account information is not on file with the merchant or directly accessible by the merchant. This is particularly true for mobile commerce transactions.

Accordingly, there is a need to develop a system involving payment transactions where a merchant's payment processing requirements are on file with a transaction facilitator and a merchant identifier is sent from the consumer's device to the transaction facilitator, where the identifier when referenced to the transaction facilitator's database determines the proffered payment provider.

### SUMMARY OF THE INVENTION

The present invention provides a commerce facilitation and stand-in payment transaction system. The stand-in payment transaction system includes a transaction facilitator offering at least one for-purchase item and purchase conditions from at least one merchant, where at least one preferred payment provider is utilized by the merchant. The system further includes at least one financial transaction network and at least one communication device for selecting the for-purchase item from the transaction facilitator offered by the merchant, where the transaction facilitator communicates payment information received from the communication device to the preferred payment provider for transacting with the financial transaction network to purchase the for-purchase item.

According to one aspect of the invention, the purchase is communicated between the merchant, the transaction facilitator and the communication device.

In a further aspect, the transaction can include a purchase, rent, lease, license, loan, barter, trade, donation, loyalty and coupon.

According to another aspect, the for-purchase item includes goods or services.

In yet another aspect of the invention, the transaction facilitator includes at least an application programming interface operating on a computer server, where the computer server is securely connected to the Internet or a dedicated communication network.

According to another aspect of the invention, the preferred payment provider includes at least one company whose regular business is acquiring electronic payment transactions and processing the electronic payment transactions.

In a further aspect, the preferred payment provider manages a list of the for-purchase items from the merchant.

According to another aspect of the invention, the transaction facilitator manages a list of the for-purchase items for the merchant.

In another aspect, the preferred payment provider connects to a third party who manages a list of for-purchase items and the purchase conditions from the merchant.

In a further aspect of the invention, upon approval of a payment the transaction facilitator communicates a list of selected for-purchase items, a payment confirmation and consumer identification to the merchant.

In another aspect of the invention, upon approval of a payment, the transaction facilitator communicates a list of the selected for-purchase items, a payment confirmation and consumer identification to the merchant via a third system.

In another aspect, upon acceptance of an order by the merchant the transaction facilitator communicates transaction receipt information and availability information of items in the order to the communication device.

According to another aspect, upon acceptance of an order by the merchant, the merchant communicates transaction receipt information and availability information of items in the order to the transaction facilitator.

In a further aspect, upon acceptance of an order by the merchant, the merchant communicates transaction receipt information and availability information of items in the order to the transaction facilitator via a third system.

In yet another aspect of the invention, upon acceptance of an order by the merchant the transaction facilitator communicates transaction receipt information and availability information of items in the order to a repository, where the transaction receipt may be tangibly received by the consumer.

According to another aspect, upon acceptance of an order by the merchant the transaction facilitator communicates transaction receipt information and availability information of items in the order to the consumer, where the communication is in a separate channel that can include text messaging or email.

In another aspect of the invention, the financial transaction network can include bank card companies, credit card companies, credit unions, paypal, banks, bill payment services, ACH providers, electronic cash systems and loyalty system providers.

In a further aspect, the communication device can include a telephone, a cell phone, a GPS device, a PDA, a smartphone, an iPhone, a Blackberry, a portable music player, an iPod or a portable computing device.

In yet another aspect of the invention, a transaction fee is paid to the transaction facilitator by a party of the transaction, where the party can include a communication device user, the financial transaction network, the preferred payment provider or the merchant.

In another aspect of the invention, information related to the transaction such as reference or tracking information, or the timing of the availability of the purchased goods or services may be communicated by the transaction facilitator to the consumers device.

In another aspect of the invention, the distance or time to arrival of the consumer to the merchant or service providers location may be communicated by the transaction facilitator to the merchant or service provider.

According to another aspect of the invention, will call information of the for-purchase item is communicated to the communication device.

### BRIEF DESCRIPTION OF THE FIGURES

The objectives and advantages of the present invention will be understood by reading the following detailed description in conjunction with the drawing, in which:

FIGS. 1(a)-1(b) show schematic views of the stand-in payment transaction system according to the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

The current invention enables mobile commerce. According to one embodiment, the invention enables the ordering of and payment for, goods and services, utilizing the Point of Interest (POI) data available to the consumer through their in-vehicle navigation system, Personal Navigation Device or handset based navigation application/service. The invention overcomes one of the major barriers to the advancement of mobile commerce by integrating the mobile ordering and payment flows into a single channel. The invention enables mobile commerce transactions to take place without any preexisting account relationship between the consumer and merchant, thereby enabling truly spontaneous anytime, anywhere transactions. According to one aspect of the invention, in the case of in-vehicle systems, the invention utilizes the payment cards the consumer already has in their purse or wallet. In the case of a handset based navigation application or service, the invention utilizes the consumer's existing payment card data loaded into a secure electronic wallet resident in the handset. The electronic wallet may be a general-purpose wallet pre-loaded onto the handset or a customized electronic wallet loaded at time of sign-up to the navigation service.

According to one aspect, the invention manages all aspects of the transaction flow. For example, a family may be travelling down a highway. Their navigation device shows their favorite fast food brand has an outlet at the next exit so they decide to stop for food. The invention allows the family to place and pay for their order while still driving to the fast food outlet. When they arrive, the family is able to avoid the line of people waiting to order in the restaurant or drive-thru as their order is complete and ready for them to collect at a premium service counter, for example.

According to another aspect, the invention manages the complete ordering process: delivery of the available menu, payment authorization once the family has made their order selection, binding of the order with the payment confirmation, communication of the order with payment details to the merchant site, communication of the order confirmation and delivery time/instructions back to the vehicle and management of an electronic receipt repository, only accessible by the cardholder.

The invention is useful at any convenience location where the consumer is mobile and can benefit from making a purchase in advance of delivery of the goods or services or on the spot, without the need to have a preexisting relationship with the merchant or service provider. Some exemplary merchants can include street meter or garage parking, electronic toll-ways, congestion road pricing systems, fast food outlets, pharmacy drive-thru's or similar retail or service environments.

According to the current invention, the merchant is not required to purchase or install additional hardware. Order and payment information can be delivered to the merchant in a number of ways depending upon the sophistication of the merchants IT system. Delivery can be as simple as receipt of a fax or email. According to one embodiment the delivery can include software integration with the merchants Electronic Cash Register or similar) ordering system. An internet/VPN or other communications channel may be required to receive orders from the transaction facilitator of the current invention. Payment authorization is handled directly from the transaction facilitator of the invention, but uses the merchants payment transaction acquiring and processing relationships and fee structure. At Settlement, transactions appear no differently than they would if the consumer swiped their card at the counter.

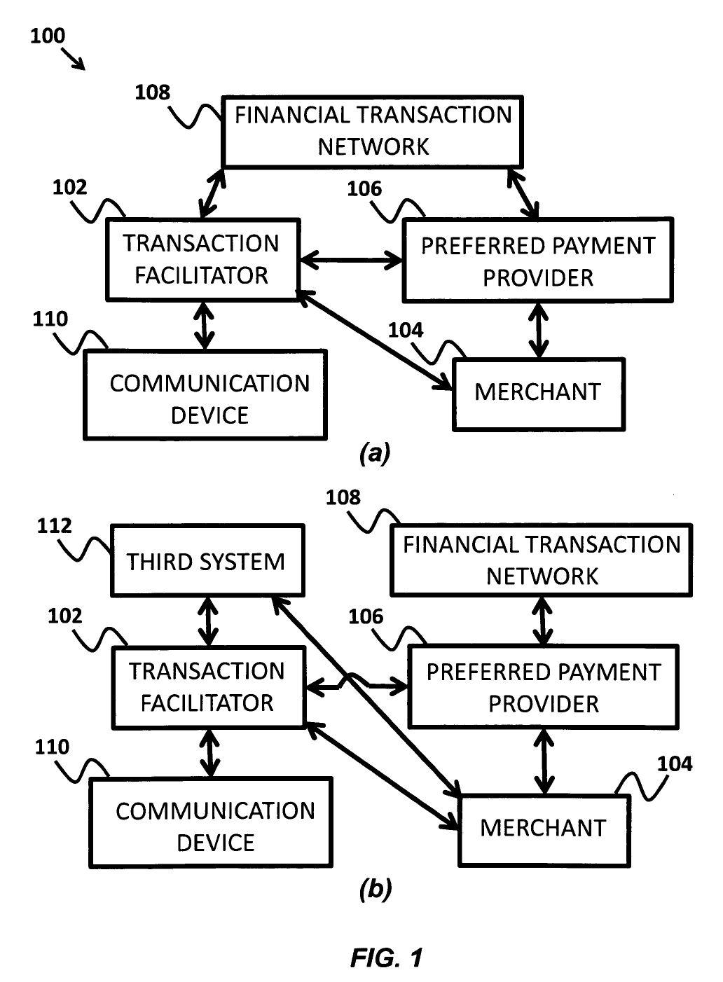

As shown in FIG. 1(a) and FIG. 1(b), the stand-in payment transaction system 100 of the current invention includes a transaction facilitator 102 that offers for-purchase items from a variety of merchants 104. A merchant 104 uses at least one preferred payment provider 106. The invention further includes a variety of financial transaction networks 108, such as a bank, or credit card company and their associated networks. A communication device 110, for example a cell phone, is used for selecting the for-purchase item from the transaction facilitator 102. The transaction facilitator 102 communicates payment information, such as a bankcard number, received from the communication device 102 to the financial transaction networks 108 via the preferred payment provider 106 to purchase the for-purchase item. Further, the transaction facilitator 102 may communicate directly with the financial transaction networks 108. According to the embodiment of FIG. 1(a), the transaction facilitator 102 either manages the menu of for-purchase items and transaction conditions, or accesses a third party system, for example 112, which contains the menu and transaction conditions. As shown in FIG. 1(b), the preferred payment provider 106 can manage the for-purchase items and provide them to the transaction facilitator 102 or, according to one aspect of the invention, the transaction facilitator 102 may operate the menu aspects of the merchant 104 itself or may reference a third system 112 that may contain that information. Here, there the third system 112 may also be other systems involved in a transaction, for example, a couponing issuing or redemption system. As an example, the consumer communication device 110 may receive a coupon as the result of a transaction, or may redeem a coupon as a part of the transaction, or a loyalty management system may be involved as part of a third system 112.

In another aspect, FIG. 1(b) shows the merchant 104 communicating directly with the transaction facilitator 102. The information communicated directly can include will call information, for-purchase item availability and timing, or menus of the for-purchase items, to name a few.

In another aspect, FIG. 1(b) shows the merchant 104 communicating directly with the third system 112. In this embodiment of the invention, the third system 112 provides and manages the two-way information flow between the merchant 104 and the transaction facilitator 102. The information communicated directly can include the for-purchase item order, payment confirmation details, will call information, for-purchase item availability and timing, or menus of the for-purchase items, to name a few.

Additionally, upon approval of a payment, the transaction facilitator 102 communicates a list of the selected for-purchase items, a payment confirmation and consumer identification to the merchant 104 via a third system 112.

In a further aspect, upon acceptance of an order by the merchant 104, the merchant 104 communicates transaction receipt information and availability information of items in the order to the transaction facilitator 102 via a third system 112.

According to another aspect, upon acceptance of an order by the merchant 104, the merchant 104 communicates transaction receipt information and availability information of items in the order to the transaction facilitator 102.

In yet another aspect of the invention, upon acceptance of an order by the merchant 104 the transaction facilitator 102 communicates transaction receipt information and availability information of items in the order to a repository (not shown), where the transaction receipt may be tangibly received by the consumer.

In another aspect of the invention, the financial transaction network 108 can include bank card companies, credit card companies, credit unions, paypal, banks, bill payment services, ACH providers, electronic cash systems and loyalty system providers.

In a further aspect, the communication device 110 can include a telephone, a cell phone, a GPS device, a PDA, a smartphone, an iPhone, a Blackberry, a portable music player, an iPod or a portable computing device.

According to the current invention, a unique identifier is assigned to each merchant or service location. A merchant or service location could be a physical store, a parking garage, a parking meter, a gas pump, or a toll way station, for example. The unique identifier is analogous to key to the database of the transaction facilitator. For each identifier the database holds a number of records. One record held in the database is a menu board of products or services offered by a merchant, which is available at that merchant location. The record held may also be a pointer to another organization that holds the menu for that merchant for example in the case of a fast food restaurant. In the exemplary case of a parking meter, the menu would be the time limit, cost per unit of time, parameters for re-feeding etc. Another key record includes the payment instructions required by the merchant or service provider. Payment instructions would include the payment types accepted, limits on the transaction value (both low and high) and importantly, instructions on the merchants preferred payment processing company, or preferred payment provider, to use and how to represent the transaction to that payment processor (for example as terminal number 6 at store number 1452).

In operation, the consumer initiates the transaction from some device such as a cell phone, a smart phone, a personal-navigation device, an in car navigation system, or anything with a user interface, communications capability and software application capability. In the exemplary case of the personal navigation device, the Point-Of-Interest (POI) database contains a record for a merchant on the consumer's route, for example the consumer searched for restaurants and decided on a fast food restaurant up the street. The POI record contains the unique merchant identifier. The merchant or service provider identifier is applied to the database record in the server of the transaction facilitator of the current invention, which contains the definition of where to get the menu for that identifier, and how to transact the payment. At the point of payment in a transaction it is not material where the cardholder's card details come from. For example, it may be from an electronic wallet in the phone, a card reader (magnetic-stripe, chip or contactless card) attached to or contained within the user interface device—as long as the transaction facilitator gets a card number, or in the case of paypal-type payment mechanisms, the account details required to perform a transaction, the transaction facilitator will process the transaction following the rules stipulated in the database record of the merchant.

According to one aspect, the current invention can use any existing payment card, or other payment mechanism, as the payment vehicle for any mobile purchase of physical world goods and services without the need for the user to pre-register or have any pre-existing relationship with the merchant or service provider.

According to one aspect, the invention includes a fee for service revenue that could be any variation or combination of an annual/quarterly/monthly Merchant Identifier registration fee, a transaction fee per payment transaction, a mobile user annual or monthly subscription fee or a one-time mobile device software application download fee.

It is the goal of the present invention to provide a system and method to overcome at least some of the disadvantages and impediments to mobile commerce. In this invention, all information required to “pay” a merchant or service provider is held and acted on by the transaction facilitator and/or may be communicated directly or indirectly to the consumer initiating the transaction on a mobile device, where the term “pay” can include any specific merchant or merchant device identifying information and/or payment process information. For example, payment process information could be a requirement to pre-authorize a $100 amount in advance of pumping gas and in some cases the payment processing information may include software code required to complete the execution of the transaction. Further, the term “directly” can include merchant details being sent to the mobile device for that device (application running on that device) to complete the payment component of a transaction using a variety of different bankcard and/or payment types that may be available to the user. For example, according to one aspect of the invention, a secure payment API can be provided for operation on the mobile device. At the purchase point of the transaction, the payment API is invoked. Additionally, the term “indirectly” can include the merchant (or service provider) information being held on a server located anywhere in the network. A unique merchant-identifying reference is used by the mobile device to access the specific merchant or service provider information, and is held in a database anywhere on the network. In this example, the payment transaction is executed by the remote server using a variety of different bankcard and/or payment types, and may be available to the consumer.

In both the direct and indirect models, the payment transaction closely approximates a payment transaction that would be made if the user were present on the merchant or service providers' premises.

Some exemplary transactions are provided herein without limitation to the invention.

### EXAMPLE 1

### Full Detail Method

The merchant' payment details are communicated to the user's mobile device, perhaps as part of another operation (GPS driving directions, business search utilizing search and mapping services provided by internet search engine companies. The user's mobile device now has all information (data fields) and process instructions required for an application running thereon to make a payment to the identified merchant. At time of settlement with the merchant or service provider's transaction acquirer/processor, the merchant will see these mobile transactions as if they were initiated by the merchant or service provider themselves. They could be differentiated or combined with existing payment types, or could be associated or differentiated as occurring at a specific payment terminal ID. According to one aspect of the current embodiment, an entity (usually a device such as a vending machine, gas pump, parking meter etc., but could also be a device identifying a server in a restaurant) is used to transmit merchant or service provider payment information, using for example short-range RF technologies among others, to the users mobile device. The transaction would then be performed by an application running on the device as described above.

### EXAMPLE 2

### A Proxy Method

According to another embodiment, a unique merchant or service provider identifier is communicated to the user's device as described above. An application in the user's mobile device then makes a request to a server of the transaction facilitator to make a payment to the identified merchant. The request to the transaction facilitator may contain references to the goods or services purchased, possibly including data pertaining to a third party involved in the ordering of the goods and services, the payment amount desired and the bankcard or other consumer payment details along with the merchant or service provider's unique identifier. The merchant or service provider identifier is used to reference a database of the transaction facilitator that contains the specific merchant payment details and processes required to complete the transaction. According to one aspect of the current embodiment, a server of a preferred payment provider performs the payment transaction with a financial transaction network, for example, as per the merchant or service provider's instructions and returns the payment approval or declined results and any other required information to the merchant or service provider, the user device and any other third parties involved in the transaction.

It is important to note when reading the example scenarios above that any application code that must be executed at the user end of the communications link may be executed in the user's mobile device, a device attached to the users device or remotely on a server or other system in the network. For example if merchant or service provider information is appended to driving directions sent to a personal or in vehicle navigation device, some or all of the software required to formulate a transaction message may be executed in the navigation device, in the attached (wireless or physical attachment) mobile device or in a combination thereof or by or in combination with a server located anywhere in the network that includes the transaction facilitator, the third system or other attached network.

There are many forms of transactions possible using the disclosed invention and all within the scope of the invention. Without limitations, the following are some further example transactions:
(i) A mobile consumer is hungry and desires to eat fast food of some description. They use their mobile device (handset, in vehicle system, kiosk etc) to search for nearby establishments. The search function may be directly to a merchants website in order to search for the closest location, utilizing a general search engine or more advanced web-Map features, where the merchant location can be represented graphically and where additional merchant details may be obtained, or through any other merchant or service provider locating and identification system. The search results for any of these methods can be augmented with information on how to remotely order the merchants product and the merchant payment information as disclosed herein. Utilizing the ordering and payment information either “directly” or “indirectly”, the consumer may select and purchase the desired product(s) from the merchant who then makes them available for pickup.
(ii) A consumer arrives at a parking place (garage or discrete meter). Bluetooth or other communication technologies are utilized to connect the parking garage or meter electronically with the consumer's mobile device (handset, in vehicle system, or other device). If the consumer chooses to utilize the connection, the electronic connection provides sufficient detail for the consumer to be able to pay for their desired or actual parking time. A component of the detail provided is the merchant identifier or payment information required to complete the payment transaction. The information communicated over the electronic link may result in a “direct” or “indirect” transaction as detailed earlier in this document.
(iii) A consumer receives driving directions to a merchant or other service provider location using GPS or other location technology. Appended to the driving directions may be sufficient ordering or payment information required for the consumer to undertake a transaction, or in the case of a multi-part transaction, initiate a transaction in advance of arriving at the location. The information received may result in a “direct” or “indirect” transaction as detailed earlier in this document.

In summary, the key concept of the invention pertains to a paradigm shift from the current account-on-file approach that keeps consumers details on file to a new approach as described in the invention where merchants' ordering and payment processing details (requirements) are on file and available to a computer application accessed by the communication device of the consumer.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For example a consumer may be driving a vehicle and determine they are low on fuel. The in vehicle or hand held navigation system may indicate the nearest gas filling station and promotional offers. On selecting a preferred gas station, the invention causes a pre-authorization transaction to occur as normally occurs when a card is first swiped at a conventional self serve gas station before pumping gas, for example. On arrival at the designated pump at the refueling station, the pump is pre enabled. On completion of pumping gas, the invention causes the payment transaction to be finalized and the amount of the actual transaction charged.

In another example, a consumer driving in a vehicle may be approaching an electronic toll road of the type that does not have a cashiers toll booth for the collection of fees for toll road usage by casual users. In this example GPS point of interest information or roadside electronic communication or physical signage may provide the driver with sufficient information to use the invention to determine and pay the appropriate fee for the type of vehicle being driven, and any other fees or information required to utilize the electronic toll way, following which the driver can use the toll way, again without the requirement to have a predefined relationship with the toll way operator or related service provider.

All such variations are considered to be within the scope and spirit of the present invention as defined by the following claims and their legal equivalents.

What is claimed:

1. A stand-in payment transaction system comprising:
a. a transaction facilitator offering at least one for-purchase item and purchase conditions from at least one merchant, wherein at least one preferred payment provider is utilized by said merchant;
b. at least one financial transaction network; and
c. at least one communication device for selecting said for-purchase item from said transaction facilitator offered by said merchant, wherein said transaction facilitator communicates payment information received from said communication device to said preferred payment provider for transacting with said financial transaction network to purchase said for-purchase item.

2. The stand-in payment transaction system of claim 1, wherein said purchase is communicated between said merchant, said transaction facilitator and said communication device.

3. The stand-in payment transaction system of claim 1, wherein said transaction is selected from a group consisting of purchase, rent, lease, license, loan, barter, trade, donation, loyalty and coupon.

4. The stand-in payment transaction system of claim 1, wherein said for-purchase item comprises goods or services.

5. The stand-in payment transaction system of claim 1, wherein said transaction facilitator comprises at least an application programming interface operating on a computer server, wherein said computer server is securely connected to the Internet or a dedicated communication network.

6. The stand-in payment transaction system of claim 1, wherein said preferred payment provider comprises at least one company whose regular business is acquiring electronic payment transactions and processing said electronic payment transactions.

7. The stand-in payment transaction system of claim 1, wherein said preferred payment provider manages a list of said for-purchase items from said merchant.

8. The stand-in payment transaction system of claim 1, wherein said transaction facilitator manages a list of said for-purchase items for said merchant.

9. The stand-in payment transaction system of claim 1, wherein said preferred payment provider connects to a third system who manages a list of said for-purchase items and said purchase conditions from said merchant.

10. The stand-in payment transaction system of claim 1, wherein upon approval of a payment said transaction facilitator communicates a list of selected said for-purchase items a payment confirmation and consumer identification to said merchant.

11. The stand-in payment transaction system of claim 1, wherein upon approval of a payment said transaction facilitator communicates a list of selected said for-purchase items a payment confirmation and consumer identification to said merchant via a third system.

12. The stand-in payment transaction system of claim 1, wherein upon acceptance of an order by said merchant said transaction facilitator communicates transaction receipt information and availability information of items in said order to said communication device.

13. The stand-in payment transaction system of claim 1, wherein upon acceptance of an order by said merchant said merchant communicates transaction receipt information and availability information of items in said order to said transaction facilitator.

14. The stand-in payment transaction system of claim 1, wherein upon acceptance of an order by said merchant said merchant communicates transaction receipt information and availability information of items in said order to said transaction facilitator via a third system.

15. The stand-in payment transaction system of claim 1, wherein upon acceptance of an order by said merchant said transaction facilitator communicates transaction receipt information and availability information of items in said order to a repository where said transaction receipt may be tangibly received by said consumer.

16. The stand-in payment transaction system of claim 1, wherein upon acceptance of an order by said merchant said transaction facilitator communicates transaction receipt information and availability information of items in said order to said consumer.

17. The stand-in payment transaction system of claim 1, wherein said financial transaction network is selected from a group consisting of bank card companies, credit card companies, credit unions, paypal, banks, bill payment services, ACH providers, electronic cash systems, couponing and loyalty system providers.

18. The stand-in payment transaction system of claim 1, wherein said communication device is selected from a group consisting of a telephone, a cell phone, a GPS device, a PDA, a smartphone, an iPhone, a Blackberry, a portable music player, an iPod and a portable computing device.

19. The stand-in payment transaction system of claim 1, wherein a transaction fee is paid to said transaction facilitator by a party of said transaction, wherein said party is selected from a group consisting of a communication device user, said financial transaction network, said preferred payment provider and said merchant.

20. The stand-in payment transaction system of claim 1, wherein tracking information, or timing of availability said for-purchase item is communicated from said transaction facilitator to said communication device.

21. The stand-in payment transaction system of claim 1, wherein distance or time to arrival of said consumer to a location of said merchant is communicated from said transaction facilitator to said merchant.

22. The stand-in payment transaction system of claim 1, wherein will call information of said for-purchase item is communicated to said communication device.
